(19) United States
(12) Patent Application Publication
(10) Pub. No.: US 2019/0005007 A1
(43) Pub. Date: Jan. 3, 2019

(54) MERGING CLIENT CONTENT WITH CLOUD SERVICES

(71) Applicant: Microsoft Technology Licensing, LLC, Redmond, WA (US)

(72) Inventors: Raja Charu Vikram KAKUMANI, Redmond, WA (US); Brandon MURDOCH, Berkshire (GB)

(21) Appl. No.: 15/640,298

(22) Filed: Jun. 30, 2017

(51) Int. Cl. G06F 17/22; G06F 17/24

(52) U.S. Cl. CPC G06F 17/2247; H04L 67/10; G06F 17/227; G06F 17/248

(57) ABSTRACT

A cloud service can be merged with a client content to provide an integrated user experience. A user interface associated with a client may be accessed. In response to accessing the user interface associated with the client, redirect instructions to navigate to a cloud service may be received. In response to receiving redirect instructions, navigation to the cloud service may be performed. In response to navigating to the cloud service, merger code may be received from the cloud service. In response to receiving the merger code, content data associated with the client may be retrieved based on the received merger code, and service content associated with the cloud service may be generated. Additionally, in response to receiving the merger code, the generated service content may be merged with the retrieved client content data into a single document, and the single document may be set to be rendered for use.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. As such, the performance of many computing tasks has become distributed across a number of different computer systems and/or a number of different computer environments.

Often, entities that have websites or applications may desire to utilize services provided by cloud computing services. For instance, a government entity may desire to utilize an authorization service provided by a cloud computing service within a website or application of the government entity. In another example, a department store may desire to utilize a credit card purchasing service provided by a cloud computing service within a website or application of the department store. Implementing such cloud services within a website or application of an entity may oftentimes be overly complicated for the entity. In other cases, while such cloud services may be simple to implement for the client, the implementation may be performed in such a way that the cloud service does not have the same, or even a similar, look and feel to other portions of the website or application of the entity.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to merging a cloud service with client content to provide an integrated user experience. For example, embodiments may include accessing a user interface associated with a client. Embodiments may also include, in response to accessing the user interface associated with the client, receiving redirect instructions to navigate to a cloud service. Embodiments may further include, in response to receiving redirect instructions, navigating to the cloud service. Embodiments may also include, in response to navigating to the cloud service, receiving merger code from the cloud service. Embodiments may further include, in response to receiving the merger code, performing a number of actions. For instance, embodiments may include retrieving content data associated with the client based on the received merger code, and generating service content associated with the cloud service. Embodiments may further include merging the generated service content with the retrieved client content data into a single document, and setting the single document to be rendered for use by the end user.

In this way, a client may have little-to-no knowledge of any business logic associated with a cloud service that the client desires to implement in a website/application of the client, while also visually implementing the cloud service with the exact look and feel of other portions of the client's website/application. More specifically, the principles described herein allow for clients to provide a seamless user experience without the client having to acquire specialized business logic skills, security skills, and so forth that cloud services (e.g., authentication dialogues) may utilize. Additionally, execution of this process (merging client content with cloud services) may be performed on the client-side (e.g., within a web browser). Such client-side execution may allow for a multi-tenant cloud service that does not execute any code with respect to different clients in the same location (i.e., on the same machine). As such, client-side execution may allow for both scalability, as processing is performed at the client, and security, as each given client may only execute code that corresponds to the given client.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates an example environment for merging a cloud services with a client content to provide an integrated user experience.

FIG. 3 illustrates a data flowchart for merging a cloud services with a client content to provide an integrated user experience example of a search tree data structure.

FIG. 4 illustrates a flowchart of a method for merging cloud services with client content to provide an integrated user experience.

### DETAILED DESCRIPTION

At least some embodiments described herein relate to merging a cloud service with client content to provide an integrated user experience. For example, embodiments may include accessing a user interface associated with a client. Embodiments may also include, in response to accessing the user interface associated with the client, receiving redirect instructions to navigate to a cloud service. Embodiments may further include, in response to receiving redirect instructions, navigating to the cloud service. Embodiments may also include, in response to navigating to the cloud service, receiving merger code from the cloud service. Embodiments may further include, in response to receiving the merger code, performing a number of actions. For instance, embodiments may include retrieving content data associated with the client based on the received merger code, and generating service content associated with the cloud service. Embodiments may further include merging the generated service content with the retrieved client content data into a single document, and setting the single document to be rendered for use by the end user.

In this way, a client may have little-to-no knowledge of any business logic associated with a cloud service that the client desires to implement in a website/application of the client, while also visually implementing the cloud service with the exact look and feel of other portions of the client's website/application. More specifically, the principles described herein allow for clients to provide a seamless user experience without the client having to acquire specialized business logic skills, security skills, and so forth that cloud services (e.g., authentication dialogues) may utilize. Additionally, execution of this process (merging client content with cloud services) may be performed on the client-side (e.g., within a web browser). Such client-side execution may allow for a multi-tenant cloud service that does not execute any code with respect to different clients in the same location (i.e., on the same machine). As such, client-side execution may allow for both scalability, as processing is performed at the client, and security, as each given client may only execute code that corresponds to the given client.

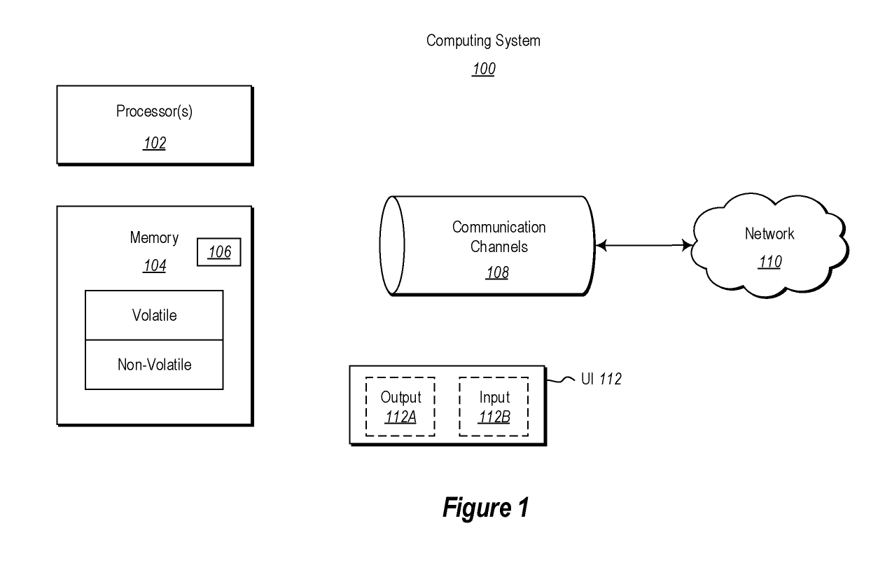

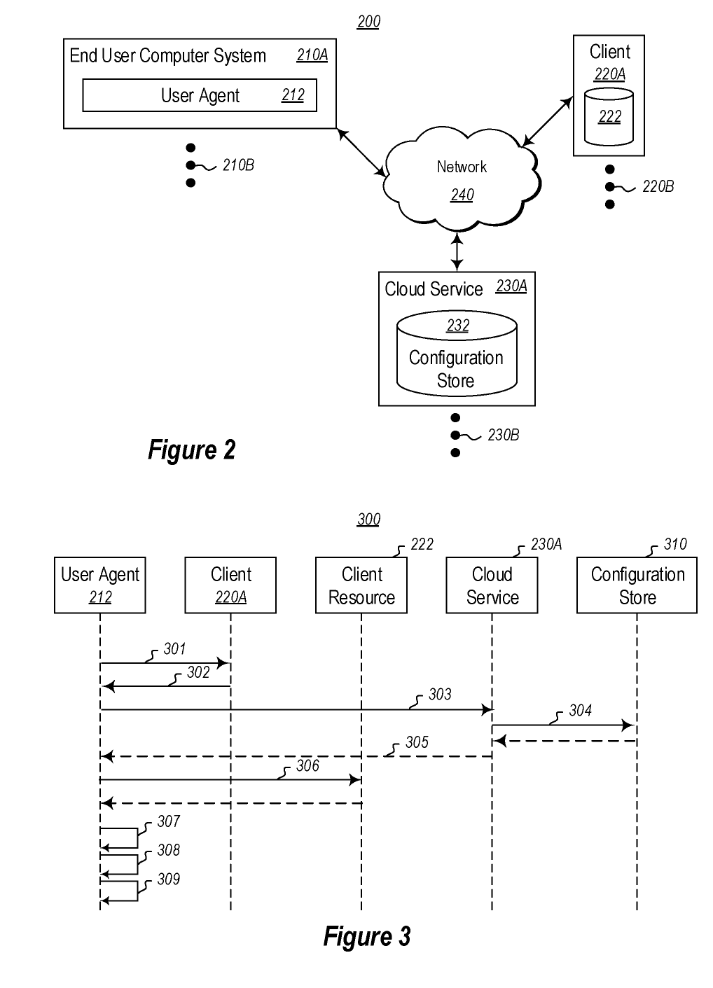

Some introductory discussion of a computing system will be described with respect to FIG. 1. Then merging a cloud service with client content to provide an integrated user experience will be described with respect to FIGS. 2 through 4.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates a computer environment 200 for merging a cloud service with client content to provide an integrated user experience. As shown, FIG. 2 includes an end user computer system 210A, a client 220A, a cloud service 230A, and a network 240. Notably, while only one end user computer system 210A, one client 220A, and one cloud service 230A are shown in FIG. 2, ellipses 210B, ellipses 220B, and ellipses 230B represent that any number of end user computer systems, any number of clients, and any number of cloud services may be used to practice the principles described herein.

The end user computer system 210A may comprise any type of computer system, including, but not limited to, a desktop computer, a laptop computer, a tablet, a smartphone, and so forth. Additionally, the end user computer system may run any type of appropriate operating system (e.g., MICROSOFT® WINDOWS®, GOOGLE™ CHROME OS™, APPLE® MACOS®, and so forth). As shown, the end user computer system includes a user agent 212. The user agent 212 may comprise any appropriate software and/or hardware that allow for accessing content of a client 220A, which client is further described herein. For instance, the user agent 212 may comprise a web browser or a native application that allows an end user to access content of the client 220A.

The client 220A may comprise any type of client associated with a website, an application (e.g., native application, web application), and so forth that allows for accessing content of the client. For instance, the client 220A may comprise a corporation that has a website or an application by which an end user of the end user computer system 210A can access content of the client via the user agent 212. As illustrated, the client 220A also includes client resource store 222. The client resource store 222 may include client resources to be used in allowing end users to access content of the client (e.g., via a website or application), as further described herein.

The cloud service 230A may comprise any type of cloud service that can be used (e.g., subscribed to) by the client 220A, and ultimately, used by an end user of content (e.g., via a website) of the client. For instance, the cloud service 230A may comprise an authentication service, a purchasing service (e.g., a credit card purchasing service), a subscription service, a scheduling service, a survey service, a shopping service, and so forth. In a specific example, the cloud service may comprise an authentication service that is utilized by the client 220A via a website of the client that allows end users to log-in (i.e., be authenticated) to the website. Such cloud services may be provided by subscription to clients (e.g., the client 220A) via a cloud computing service (e.g., MICROSOFT® AZURE®, AMAZON® WEB SERVICES (AWS®), and so forth). Notably, while particular examples of cloud services (e.g., authentication services, shopping service, and so forth) are enumerated herein, such enumeration of cloud services is described for exemplary purposes only. As such, the principles described herein may be practiced utilizing essentially any type of cloud service that can be utilized by the client 220A.

As illustrated, the cloud service 230A also includes a configuration store 232. The configuration store 232 may include configuration data associated with one or more clients (e.g., the client 220A) of the cloud service 230A, as further described herein. As briefly mentioned, the environment 200 also includes the network 240. The network 240 may comprise any type network that allows for communication between the end user computer system 210A, the client 220A, and the cloud service 230A. For instance, the network 240 may comprise an internet network that allows each of the end user computer system 210A, the client 220A, and the cloud service 230A to communicate with one another. Accordingly, the network 240 may comprise the network 110, as described with respect to FIG. 1.

Previously when a client (e.g., the client 220A) has desired to utilize a cloud service within a website or application of the client, the client has had limited options for how to implement the cloud service. For instance, the cloud service may be exposed to a client through application programming interfaces (API's) or software development kits (SDK's). However, such implementations can include extensive, often burdensome, work on the part of the client related to communicating with, and utilizing, the API's/SDK's of the cloud service, assuming the client desires to control the look and feel of the implementation of the cloud service within the website/application of the client. Alternatively, such a client has previously been able to leave such work to the cloud service, while having little-to-no ability to modify the look and feel of implementing the cloud service. Accordingly, the principles described herein may allow for implementing the look and feel of a client's website/application with respect to implementation of a cloud service within the website/application without overly burdening such a client. More particularly, the principles described herein have several advantages over other previous approaches, in that the principles described herein allow clients to provide a seamless user experience without the client having to acquire specialized JAVASCRIPT® skills, security skills, and so forth that cloud services (e.g., authentication dialogues) may require.

FIG. 3 illustrates a data flowchart for merging cloud service code (e.g., code associated with the cloud service 230A) with content of the client 220A to provide an integrated user experience for an end user. Such cloud service code, for example, may comprise business logic associated with actually performing the particular cloud service (e.g., authentication) As illustrated, initially, the user agent may send communication 301 to the client 220A to access content of the client. For example, an end user of the end user computer system 210A may use the user agent 212 (e.g., a web browser) to navigate to a website of the client 220A. Using the previous example, upon navigating to the website of the client 220A, the end user may attempt to use a particular portion of content of the website, which portion of content comprises functionality provided by the cloud service 230A. For instance, the end user may have attempted to authenticate (i.e., log-in) to the website of the client, which authentication is performed by the cloud service 230A.

Upon attempting to use the particular portion of content of the website that comprises functionality provided by the cloud service 230A, the website/application of the client 220A may generate communication 302, redirecting (e.g., using HTTP redirect 302) the user agent to the cloud service 230A. Accordingly, the user agent 212 may then send communication 303 to the cloud service 230A in response to being redirected by communication 302. Upon receiving the communication 303, the cloud service 230A may retrieve configuration data comprising pointers to content data associated with the website/application of the client 220A from the configuration store 232, as shown in communication 304. For instance, such content data may comprise hypertext markup language (HTML) and/or cascading style sheets (CSS) associated with the look-and-feel of the website/application associated with the client. As briefly described, the configuration data included within the configuration store may comprise pointers (i.e., pointers to a particular storage location) to content data (e.g., HTML and/or CSS) of the client that is stored in a separate location (e.g., by the client itself), as further described herein.

Upon retrieving the configuration data (i.e., pointers to the content data associated with the website/application of the client), the cloud service may send the pointers, as well as merger code that comprises code capable of merging cloud service code (e.g., business logic associated with performing the cloud service) with the client content data (i.e., HTML/CSS associated with the website/application of the client), to the user agent 212, as shown by communication 305. More specifically, such merger code may include at least three particular portions of code, a first portion for facilitating the merging of the client content data (i.e., client code) with cloud service code, a second portion configured to handle any business logic associated with the cloud service (e.g., authentication), and a third portion that relates to retrieving the content data of the client in response to receiving the pointers. In an example, such merger code may comprise a combination of JAVASCRIPT and JAVASCRIPT OBJECT NOTATION (JSON). For instance, such JAVASCRIPT may be configured to facilitate making any appropriate application programming interface (API) calls to the cloud service, while the JSON may include pointers (e.g., address(es) such as a uniform resource locator (URL)) to the client content data, and may further be configured to retrieve the content data associated with the client 220A.

As shown, upon receiving the merger code in communication 305, the user agent may perform a request for the actual client content data associated with the client 220A. Accordingly, the user agent may receive the pointers in communication 305, and respond to the received pointers by sending communication 306 to retrieve the client content data (i.e., HTML and/or CSS associated with a website/application of the client). Communication 306 may comprise XMLHttpRequest and/or cross-origin resource sharing (CORS) protocols that allow the user agent to stay in control over the process of fetching the client content data.

Furthermore, in response to receiving communication 305, the user agent 212 may also generate service content associated with the cloud service, as shown by line 307. Such service content may comprise a template (e.g., a HANDLEBARS template) associated with the cloud service 230A that has been compiled by the user agent to form HTML (i.e., the resulting HTML comprises the service content). The template may either be included in the merger code sent to the user agent 212 in communication 305 or may be retrieved by the user agent based on instructions included within the merger code (i.e., the second portion of the merger code associated with handling business logic of the cloud service). The template may be configured to handle various business logic associated with performance of the cloud service (e.g., authentication). In some embodiments, the service content may comprise HTML that is the result of compiling the template along with data associated with the particular cloud service. For instance, assume the cloud service comprises authentication. In such an example, the template is associated with at least portions of the business logic of performing authentication, while the data may comprise one or more policies associated with performing authentication (e.g., policies associated with the particular client 220A).

Upon generating the service content associated with the cloud service and retrieving the content data associated with the client, the user agent may utilize the merger code to merge the service content with the content data associated with the client to create a single HTML document that includes both the service content of the cloud service and the content data of the client, as shown by line 308. For instance, the client content data (or document) may include a placeholder for injecting the service content. This single HTML document may then be processed and set as a dynamic document that is rendered for use by an end user via the user agent 212. For instance, assuming the cloud service comprises authentication, the end user may authenticate to a particular website/application such that the visual process of authenticating includes the same look and feel to the end user as the rest of the website/application.

In this way, the client 220A may have little-to-no knowledge of any business logic associated with the cloud service, while also visually implementing the cloud service with the exact look and feel of other portions of the client's website/application. Accordingly, the content data (i.e., HTML/CSS) of the client that is retrieved may be modified/manipulated in anyway by the client to have a particular look and feel. More specifically, the principles described herein may provide a simplified and flexible cloud service (e.g., authentication) experience while allowing complete customization of the cloud service experience within the website/application of the client through modification of HTML and CSS (e.g., the HTML and CSS of the content data of the client). Notably, in some embodiments, the cloud service may also allow for manipulation of JAVASCRIPT associated with the cloud service. In other embodiments, however, a client may not be allowed to manipulate anything other than HTML and CSS associated with the look and feel of the cloud service implemented within the website/application of the client. The particular look and feel may then be merged with the cloud service in such a way that the website/application of the client implements the cloud service with the same look and feel as other portions of the client's website/application, without the client having to manipulate any code associated with the cloud service.

Notably, as described herein, execution of this process (and more specifically, the merger code) is generally described as being performed on the client-side (i.e., within the user agent 212). Such client-side execution allows for a multi-tenant cloud service that does not execute any code with respect to different clients in the same location (i.e., on the same machine). As such, client-side execution allows for both scalability, as processing is performed at the client, and security, as each given client may only execute code that corresponds to the given client. While there are numerous benefits to such client-side execution, the principles described herein may also be performed in any other appropriate location (e.g., at the cloud service).

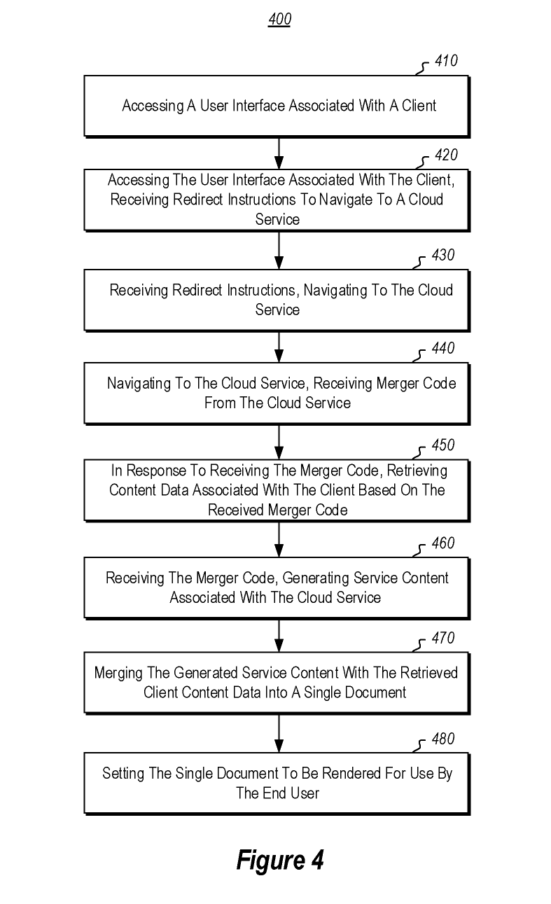

FIG. 4 illustrates a flowchart of a method 400 for merging a cloud service with client content to provide an integrated user experience. The method 400 is described with frequent reference to FIGS. 2 and 3. The method 400 may include accessing a user interface associated with a client (Act 410). For instance, user interaction may be received associated with browsing to a website of a client or opening an application of the client. The method 400 may further include, in response to accessing the user interface associated with the client, receiving redirect instructions to navigate to a cloud service (Act 420). For instance, in response to navigating to the website of the client (or opening the application of the client), the browser (or application) may receive directions associated with being redirected to a cloud service (e.g., authentication) of the client. In some embodiments, the redirect may occur in response to receiving user input associated with using the cloud service (e.g., authentication) within the website or application of the client.

The method 400 may also include, in response to receiving redirect instructions, navigating to the cloud service (Act 430). Accordingly, in response to receiving redirect instructions, the web browser or application may redirect to the cloud service. The method 400 may further include, in response to navigating to the cloud service, receiving merger code from the cloud service (Act 440). For instance, upon receiving communication 303 from the user agent 212 (e.g., a web browser or application), the cloud service may send communication 305 that includes merger code to the user agent. Such merger code, as further described herein, may include a first portion for facilitating the merging of content data associated with the client (i.e., client code) with cloud service code, a second portion configured to handle any business logic associated with the cloud service (e.g., authentication), and a third portion that relates to retrieving the content data of the client (i.e., retrieval being performed by the user agent) in response to receiving the merger code.

The method 400 may further include, in response to receiving the merger code, retrieving content data associated with the client based on the received merger code (Act 450). More specifically, the merger code received in communication 305 may include instructions to retrieve content data associated with the client, as well as how to retrieve the content data (e.g., pointers to the storage location of the content data). Based on such instructions, the user agent may then retrieve the content data. The method 400 may also include generating service content associated with the cloud service (Act 460). Such service content may comprise a template (e.g., a HANDLEBARS template) associated with the cloud service 230A that has been compiled by the user agent to form HTML (i.e., the resulting HTML comprises the service content). The method 400 may further include merging the generated service content with the retrieved client content data into a single document (Act 470). For instance, based on code and instructions included within the merger code, the user agent may then merge the content data of the client and the service content to form a single document (i.e., HTML). The method 400 may further include setting the single document to be rendered for use by the end user (Act 480). Accordingly, the single document may then be set and rendered for use by an end user of the user agent 212.

Accordingly, using the principles described herein, a user may access a service that looks to the user as if the service is provided by a client, while the service is actually provided by a cloud service using the website/application of the client. As such, the client may configure any data associated with the website/application (e.g., CSS, HTML, metadata, and so forth), such that when the cloud service renders a user experience associated with cloud service, the user experience of the service is completely seamless to the end user. As further described herein, such an experience may be accomplished at least partially by the cloud service sending merger code and client configuration (e.g., pointers to client content data) to the user agent (e.g., a browser being used by an end user). The user agent may then run the merger code, which in turn fetches the client content and merges the client content with the cloud service to provide a seamless user experience associated with the service (e.g., the service accessed via the website/application of the client and provided by the cloud service).

In this way, a client may have little-to-no knowledge of any business logic associated with a cloud service that the client desires to implement in a website/application of the client, while also visually implementing the cloud service with the exact look and feel of other portions of the client's website or application. More specifically, the principles described herein allow for clients to provide a seamless user experience without the client having to acquire specialized business logic skills, security skills, and so forth that cloud services (e.g., authentication dialogues) may utilize. Additionally, execution of this process (merging client content with a cloud service) may be performed on the client-side (e.g., within a web browser). Such client-side execution may allow for a multi-tenant cloud service that does not execute any code with respect to different clients in the same location (i.e., on the same machine). As such, client-side execution may allow for both scalability, as processing is performed at the client, and security, as each given client may only execute code that corresponds to the given client.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer system comprising:
one or more processors; and
one or more computer-readable storage media having stored thereon computer-executable instructions that are executable by the one or more processors to cause the computer system to merge a cloud service with a client content to provide an integrated user experience, the computer-executable instructions including instructions that are executable to cause the computer system to perform at least the following:
access, from a client computer system, user interface content associated with the client computer system;
based on accessing the user interface content, receive redirect instructions to navigate to a cloud service at a cloud service computer system;
based on the redirect instructions, navigate to the cloud service computer system;
based on navigating to the cloud service computer system, receive, from the cloud service computer system, (i) merger code and (ii) one or more pointers to client content at the client computer system, the merger code including:
a first code portion for merging the client content with service content associated with the cloud service computer system, and
a second code portion comprising business logic associated with the cloud service computer system;
in response to receiving the merger code and the one or more pointers, perform at least the following:
retrieving the client content from the client computer system based on the one or more pointers;
generating the service content associated with the cloud service computer system, the service content including the business logic associated with the cloud service computer system;
merging the generated service content with the retrieved client content; and
rendering the merged service content and client content.

2. The computer system in accordance with claim 1, wherein the cloud service comprises an authentication service.

3. The computer system in accordance with claim 1, wherein the merger code includes one or more of: (i) a portion of code that comprises JavaScript, (ii) a portion of code that comprises JavaScript object notation (JSON), or (iii) a handlebars template.

4. The computer system in accordance with claim 1, wherein generating the service content comprises compiling at least a handlebars template associated with the merger code to thereby create hypertext markup language (HTML).

5. The computer system in accordance with claim 1, wherein the merger code includes instructions to retrieve the client content.

6. The computer system in accordance with claim 5, wherein retrieving the client content is performed using at least one of an XMLHttpRequest or a cross-origin resource sharing (CORS).

7. The computer system in accordance with claim 1, wherein the client content comprises at least one of HTML or cascading style sheets (CSS).

8. The computer system in accordance with claim 1, wherein accessing the user interface content associated with the client computer system comprises navigating to a website of the client.

9. A method, implemented at a computer system that includes one or more processors, for merging a cloud service with a client content to provide an integrated user experience, comprising:
accessing, from a client computer system, user interface content associated with the client computer system;
based on accessing the user interface content, receiving redirect instructions to navigate to a cloud service at a cloud service computer system;
based on the redirect instructions, navigating to the cloud service computer system;
based on navigating to the cloud service computer system, receiving, from the cloud service computer system, (i) merger code and (ii) one or more pointers to client content at the client computer system, the merger code including:
a first code portion for merging the client content with service content associated with the cloud service computer system, and
a second code portion comprising business logic associated with the cloud service computer system;
in response to receiving the merger code and the one or more pointers, performing at least the following:
retrieving the client from the client computer system based on the one or more pointers;
generating the service content associated with the cloud service, the service content including the business logic associated with the cloud service computer system;
merging the generated service content with the retrieved client content data; and
rendering the merged service content and client content.

10. The method in accordance with claim 9, wherein the cloud service comprises a scheduling service.

11. The method in accordance with claim 9, wherein the merger code includes one or more of (i) a portion of code that comprises JavaScript, (ii) a portion of code that comprises JavaScript object notation (JSON), or (iii) a handlebars template.

12. The method in accordance with claim 9, wherein generating the service content comprises compiling at least a handlebars template associated with the merger code to thereby create hypertext markup language (HTML).

13. The method in accordance with claim 9, wherein the merger code includes instructions to retrieve the client content.

14. The method in accordance with claim 13, wherein retrieving the client content is performed using at least one of an XMLHttpRequest or an cross-origin resource sharing (CORS).

15. The method in accordance with claim 9, wherein the client content comprises at least one of HTML or cascading style sheets (CSS).

16. The method in accordance with claim 9, wherein accessing the user interface content associated with the client computer system comprises accessing an application of the client.

17. A computer program product comprising one or more hardware storage devices having stored thereon computer-executable instructions that are executable by one or more processors of a computer system to merge a cloud service with client content to provide an integrated user experience, the computer-executable instructions including instructions that are executable to cause the computer system to perform at least the following:
access, from a first remote computer system, user interface content associated with a client;
based on accessing the user interface content, receive redirect instructions to navigate to a cloud service at a second remote computer system;
based on the redirect instructions, navigate to the cloud service at the second remote computer system;
based on navigating to the cloud service, receive, from the second remote computer system, (i) merger code and (ii) one or more pointers to client content, the merger code including:
a first code portion for merging the client content with service content associated with the cloud service, and
a second code portion comprising business logic associated with the cloud service;
in response to receiving the merger code and the one or more pointers, perform at least the following:
retrieving the client content based on the one or more pointers;
generating the service content associated with the cloud service, the service content including the business logic associated with the cloud service;
merging the generated service content with the retrieved content data; and
endering the merged service content and client content.

18. The computer program product in accordance with claim 17, wherein the cloud service comprises a survey service.

19. The computer program product in accordance with claim 17, wherein the merger code includes one or more (i) a portion of code that comprises JavaScript, (ii) a portion of code that comprises JavaScript object notation (JSON), or (iii) a handlebars template.

20. The computer program product in accordance with claim 17, wherein generating the service content comprises compiling at least a handlebars template associated with the merger code to thereby create hypertext markup language (HTML).
